(19) United States
(12) Patent Application Publication
(10) Pub. No.: US 2018/0102698 A1
(43) Pub. Date: Apr. 12, 2018

(54) ROTOR MANUFACTURING METHOD

(71) Applicant: HONDA MOTOR CO., LTD., Tokyo (JP)

(72) Inventors: Akikazu IWAMOTO, Saitama (JP); Keisuke AZUSAWA, Saitama (JP)

(73) Assignee: HONDA MOTOR CO., LTD., Tokyo (JP)

(21) Appl. No.: 15/728,713

(22) Filed: Oct. 10, 2017

(30) Foreign Application Priority Data
Oct. 11, 2016 (JP) 2016-200175

(51) Int. Cl. H02K 15/12; H02K 15/03; H02K 1/27; H02K 1/28

(52) U.S. Cl. CPC H02K 15/12; H02K 1/28; H02K 1/276; H02K 15/03

(57) ABSTRACT

In the rotor manufacturing method, a plurality of resin tablets (150) are disposed to be annularly spaced from each other in resin tablet disposing step (S230), and resin (150a) is filled between a magnet insertion hole (14) and a permanent magnet (40) in resin filling step (S240) when the plurality of resin tablets (150) are pressed by one plunger (112). Therefore, it is possible to reduce the amount of cull which is a residual cured product of a resin material.

### CROSS-REFERENCE TO RELATED APPLICATION

This application claims priority from Japanese Patent Application No. 2016-200175 filed on Oct. 11, 2016, the entire contents of which are incorporated herein by reference.

### TECHNICAL FIELD

The present invention relates to a rotor manufacturing method of manufacturing a rotor by fixing a magnet to a rotor core.

### BACKGROUND ART

In the related art, a rotary electric machine used for a hybrid vehicle or the like is configured in which a rotor is rotatably supported inside a case. In the rotor, permanent magnets are fixed to a plurality of magnet insertion holes formed along a circumferential direction of the rotor core.

As one of a rotor manufacturing method of such a rotary electric machine, a so-called resin injection method is known in which after the permanent magnets are inserted into the magnet insertion holes of the rotor core, resin is injected from resin insertion holes provided in the magnet insertion holes, and the resin is solidified to fix the permanent magnets (for example, patent literature 1).

As a method of injecting the resin into the resin injection holes provided in the magnet insertion holes, as illustrated in FIG. 9, there is so-called transfer molding in which a rotor core 1 is disposed on a lower die 2, a gate die 3 is placed above the rotor core 1, and a resin tablet 5 is pressed by a plunger 6 in a state where an upper die 4 is placed above the gate die 3, whereby the resin is injected.

Here, the gate die 3 has gates 3a which are a plurality of resin flow channels formed radially as illustrated in FIG. 10, and a tip part of the gate 3a branches and continues to a plurality of resin injection holes 3c of a lower gate die 3b. The resin of a resin tablet 5 located at a central part thereof is injected into each of magnet insertion holes 1a from the resin injection holes 3c, as illustrated in FIG. 9.

As a step of injecting the resin in the transfer molding, first, permanent magnets 1b are inserted into the magnet insertion holes 1a of the rotor core 1 as illustrated in FIG. 11A, and the rotor core 1 is preheated as illustrated in FIG. 11B.

Subsequently, as illustrated in FIG. 11C, resin 5a is injected into the magnet insertion holes 1a through the resin injection holes 3c of the gate die 3 by pressing the resin tablet 5 with the plunger 6. Then, as illustrated in FIG. 11D, the resin 5a is heated and cured, and the resin 5a is cooled and solidified as illustrated in FIG. 11E, whereby the permanent magnets 1b are fixed to the magnet insertion hole 1a.

### RELATED ART LITERATURE

### Patent Literature

Patent Literature 1: JP-A-2008-219992

### SUMMARY OF THE INVENTION

### Problem that the Invention is to Solve

However, when the resin 5a is injected by the transfer molding described above, extra resin called cull, which is a residual cured product of the resin 5a having substantially the same shape as that of the gate 3a, remains in the gate 3a of the gate die 3, so there is a problem that the production yield is reduced.

The invention has been made in view of the above problems, and an object thereof is to a rotor manufacturing method capable of reducing the amount of cull which is a residual cured product of a resin material.

### Means for Solving the Problem

In order to achieve the above object, according to an invention of aspect 1, there is a rotor manufacturing method of manufacturing a rotor including

a rotor core (for example, a rotor core 20 in an embodiment) having a plurality of magnet insertion holes (for example, magnet insertion holes 14 sin an embodiment),

a magnet (for example, permanent magnets 40 in an embodiment) which is disposed in the magnet insertion hole, and

a resin portion (for example, resin portions 43 in an embodiment) which is filled between the magnet and the magnet insertion hole,

wherein the method includes the steps of:

disposing (for example, resin tablet disposing step S230 in an embodiment) a plurality of resin tablets (for example, resin tablets 150 in an embodiment) to be annularly spaced from each other; and

filling (for example, resin filling step S240 in an embodiment) resin (for example, resin 150a in an embodiment) between the magnet insertion hole and the magnet by pressing the plurality of resin tablets with one plunger (for example, a plunger 112 in an embodiment).

According to an invention of aspect 2, in the invention of aspect 1,

the plurality of resin tablets are disposed at equal intervals on a circumference with an axial center of the rotor core as a center, and

the plunger has a plurality of pressing portions (for example, pressing portions 114 in an embodiment).

According to an invention of aspect 3, in the invention of aspect 1,

the resin tablet is disposed in a resin tablet disposing portion (for example, a resin tablet disposing portion 132 in an embodiment) surrounded by a support wall (for example, a support wall 132b in an embodiment).

According to an invention of aspect 4, in the invention of aspect 1,

the resin tablet is disposed substantially at an intermediate position between the axial center of the rotor core and the magnet insertion hole.

According to an invention of aspect 5, in the invention of aspect 1,

a resin filling die (for example, a transfer molding die 100 in an embodiment) is provided on one end face (for example, an upper end face 22 in an embodiment) in an axial direction of the rotor core, and

the resin filling die includes

a first plate (for example, a plunger plate 110 in an embodiment) where which the plunger is formed,

a second plate (for example, a cylinder plate 120 in an embodiment) where a cylinder (for example, a cylinder 122 in an embodiment) is formed, the plunger being inserted through the cylinder,

a third plate (for example, a gate plate 130 in an embodiment) where a plurality of resin tablet disposing portions (for example, the resin tablet disposing portion 132 in an embodiment) and a plurality of radial resin flow channels (for example, gates 134 in an embodiment) are formed, wherein the resin tablets are disposed in the resin tablet disposing portions, and the radial resin flow channels extend in a radial direction from the resin tablet disposing portions toward the magnet insertion holes, and

a fourth plate (for example, a resin injection plate 140 in an embodiment) where a plurality of axial resin flow channels (for example, resin injection holes 142 in an embodiment) are formed, wherein the axial resin flow channels communicate with the radial resin flow channels and extend in an axial direction toward the magnet insertion holes.

According to an invention of aspect 6, in the invention of aspect 5,

an annular connection groove (for example, a connection groove 138 in an embodiment) is formed in the third plate to connect the radial resin flow channels with each other.

### Advantage of the Invention

According to the invention of aspect 1, the resin is injected into the plurality of magnet insertion holes using the plurality of resin tablets disposed to be annularly spaced from each other, and thus the amount of cull being a residual cured product can be reduced, compared with a case where the resin is injected into the plurality of magnet insertion holes using one resin tablet. Since the plurality of resin tablets are pressed by one plunger, the plunger can be easily controlled compared with a case where the resin tablets are pressed by a plurality of plungers, respectively. Further, since so-called transfer molding is adopted in which the resin tablet is pressed by the plunger, the injection pressure can be set to be lower compared with injection molding.

According to the invention of aspect 2, since the plurality of resin tablets are disposed at equal intervals on the circumference with the axial center of the rotor core as a center and the plunger has the plurality of pressing portions, the load can be evenly applied to the plurality of resin tablets at the time of pressing with one plunger.

According to the invention of aspect 3, since the resin tablet is disposed in the resin tablet disposing portion surrounded by the support wall, the resin tablet can be firmly held.

According to the invention of aspect 4, since the resin tablet is disposed substantially at the intermediate position between the axial center of the rotor core and the magnet insertion hole, it is possible to reduce the amount of cull which is a residual cured product, compared with a case where the resin tablet is disposed on the axial center of the rotor core.

According to the invention of aspect 5, since the resin filling die includes the first to fourth plates, each plate can be formed according to the function. In addition, the plate formed with the radial resin flow channel is separated from the plate formed with the axial resin flow channel, and thus it is possible to easily remove the cull which is the residual cured product.

According to the invention of aspect 6, since the annular connection groove is formed in the third plate to connect the radial resin flow channels with each other, the pressure can be uniformly applied during the injection of the resin.

### BRIEF DESCRIPTION OF DRAWINGS

FIG. 1 is a perspective view of a rotor used in a rotor manufacturing method according to an embodiment of the invention.

FIG. 2A is a perspective view illustrating a transfer molding die used in the rotor manufacturing method according to the embodiment of the invention, and FIG. 2B is a sectional perspective view of FIG. 2A.

FIG. 3 is a perspective view of a plunger as seen from the back side of a plunger plate.

FIG. 4 is a plan view of a gate plate.

FIG. 5A is a perspective view illustrating a structure around a resin tablet disposing portion, and FIG. 5B is a perspective view illustrating a state where the resin tablet is disposed in the resin tablet disposing portion.

FIGS. 6A to 6C are views illustrating use states of the transfer molding die, wherein FIG. 6A is a side view before the plunger is pressed, FIG. 6B is a sectional view of FIG. 6A, and FIG. 6C is a sectional view when the plunger is pressed.

FIGS. 7A to 7C are views illustrating a flow of resin in the transfer molding die, wherein FIG. 7A is a sectional view before the plunger is pressed, FIG. 7B is a sectional view at the start of pressing of the plunger, and FIG. 7C is a sectional view when the plunger is pressed.

FIG. 8 is a flowchart of the rotor manufacturing method according to the embodiment of the invention.

FIG. 9 is a partial sectional view of a transfer molding die used in a rotor manufacturing method according to the related art.

FIG. 10 is a plan view illustrating a gate die used in the rotor manufacturing method according to the related art.

FIGS. 11A to 11E are explanatory diagrams illustrating steps of the rotor manufacturing method according to the related art.

### MODE FOR CARRYING OUT THE INVENTION

A rotor manufacturing method according to an embodiment of the invention will be described below with reference to the accompanying drawings. Note that the drawings are to be seen in a direction in which reference numerals given therein look normal.

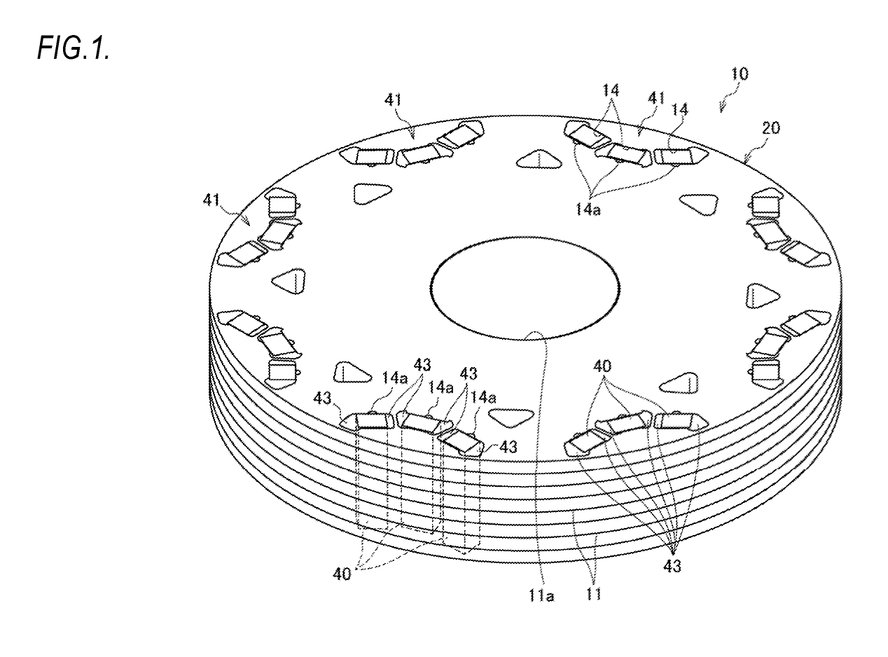

First, a rotor core used in the rotor manufacturing method according to the embodiment of the invention will be described with reference to FIG. 1.

A so-called permanent magnet embedded rotor 10 used for a rotary electric machine generally includes a rotor core 20, a plurality of permanent magnets 40, and a resin portion 43 for fixing the permanent magnets 40 to the rotor core 20.

The rotor core 20 is constituted by stacking a plurality of electromagnetic steel sheets 11 having substantially an annular shape, and has a shaft hole 11a at the center thereof and a plurality of magnet insertion holes 14 at an outer peripheral portion thereof. In the example illustrated in FIG. 1, three magnet insertion holes 14 constitute one magnetic pole 41.

Each of the magnet insertion holes 14 is provided with a resin groove 14a extending in an axial direction along the magnet insertion hole 14, and resin flows in from the resin groove 14a by transfer molding to be described below, whereby the permanent magnet 40 is fixed.

The three magnet insertion holes 14 constituting one magnetic pole 41 are disposed such that two magnet insertion holes 14 located on both sides are opened to an outer diameter side in a V shape with respect to the magnet insertion hole 14 located at the center. The magnet insertion holes 14 are opened in the axial direction, and are independent from each other.

In the three magnet insertion holes 14 constituting one magnetic pole 41, the permanent magnets 40 having the same magnetization direction are disposed. In the magnetic poles 41 adjacent to each other in a circumferential direction, permanent magnets 40 different in magnetization direction from the above permanent magnets 40 are disposed, so that magnetic poles are alternately inverted in the circumferential direction.

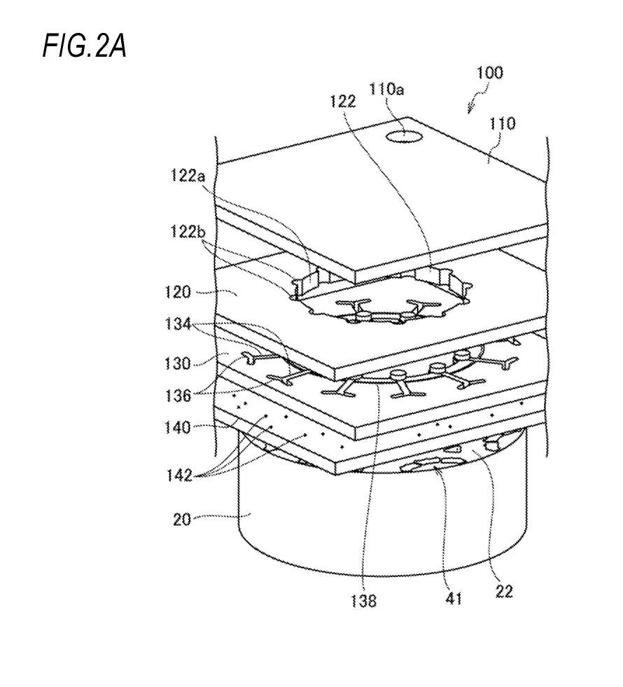

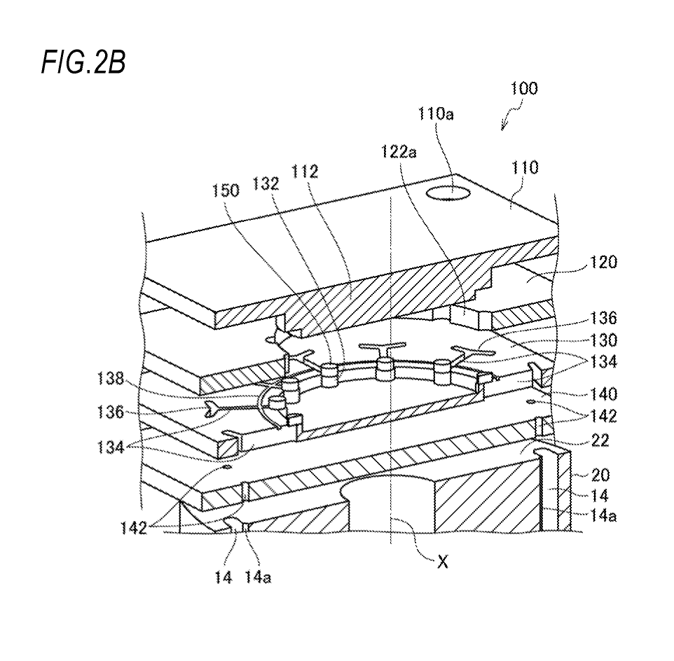

A transfer molding die used in the rotor manufacturing method according to the embodiment will be described below with reference to FIGS. 2A and 2B. In FIGS. 2A and 2B, the permanent magnet 40 will not be presented.

A transfer molding die 100 includes a plunger plate 110, a cylinder plate 120, a gate plate 130, and a resin injection plate 140, and the transfer molding die 100 is disposed on an upper end face 22 of the rotor core 20.

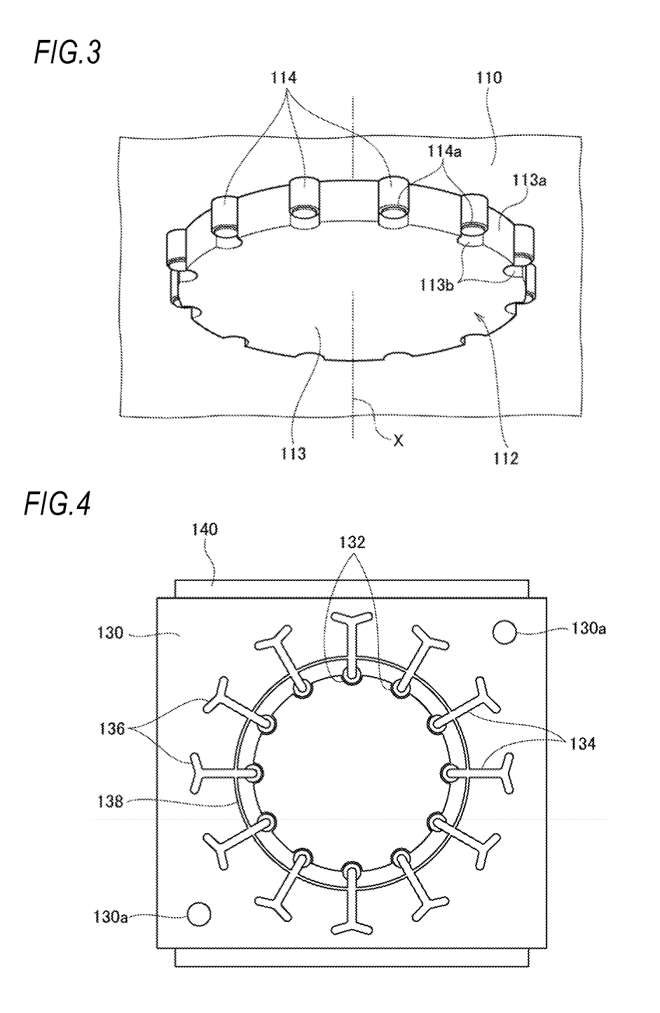

The plunger plate 110 is formed in a rectangular flat plate shape, and a plunger 112 is projected on a lower side thereof as illustrated in FIG. 3. In the plunger 112, a plurality of pressing portions 114 each having a columnar shape are formed at equal intervals around a columnar plunger base 113 having the same axial center as an axial center X of the rotor core 20.

A substantially inside (axial center X side) semicircle of the semicircle pressing portion 114 overlaps with the plunger base 113, and a plurality of semicircular cutout portions 113b cut out along the columnar pressing portions 114 are formed on an outer peripheral surface 113a of the plunger base 113.

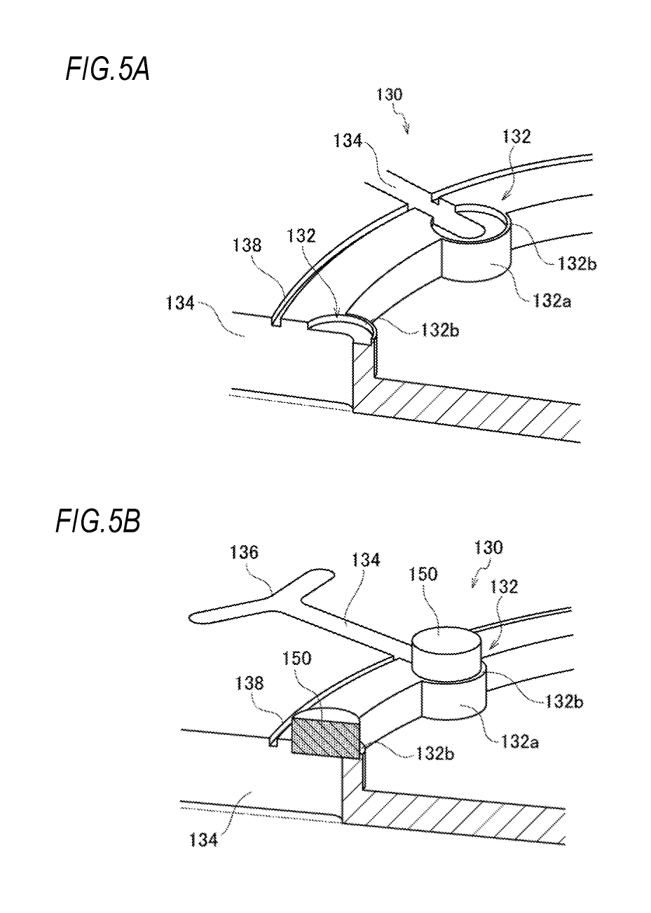

The outer peripheral surface 113a of the plunger base 113 is in sliding contact with an inner peripheral surface 122a of a cylinder 122 formed on a cylinder plate 120 when the plunger 112 is pressed, and the cutout portion 113b is in sliding contact with an outer peripheral surface 132a (see FIGS. 5A and 5B) of a resin tablet disposing portion 132 formed on the gate plate 130.

Each of the pressing portions 114 is formed with a stepped portion 114a in which an outer peripheral edge is cut out into a stepwise shape. The stepped portion 114a is engaged with a support wall 132b of the resin tablet disposing portion 132 formed on the gate plate 130 when the plunger 112 is pressed.

The cylinder plate 120 is formed in rectangular flat plate shape as illustrated in FIGS. 2A and 2B, and the cylinder 122 is formed at the central part thereof to allow the plunger 112 of the plunger plate 110 to be inserted therethrough.

A plurality of semicircular grooves 122b in sliding contact with outer peripheral surfaces of the pressing portions 114 are formed on the inner peripheral surface 122a of the cylinder 122 at positions corresponding to the respective pressing portions 114 of the plunger 112. As described above, the inner peripheral surface 122a is in sliding contact with the outer peripheral surface 113a of the plunger base 113 when the plunger 112 is pressed.

The semicircular groove 122b circularly surrounds the outer periphery of the resin tablet 150 together with the cutout portion 113b of the plunger base 113 at the start of pressing of the plunger 112 and constrains the outer periphery of the resin tablet 150.

As illustrated in FIGS. 2A, 2B, 4, 5A, and 5B, the gate plate 130 is formed in a rectangular flat plate shape, and the resin tablet disposing portions 132 are formed at positions corresponding to the respective pressing portions 114 of the plunger 112. As described above, the outer peripheral surface 132a of the resin tablet disposing portion 132 is in sliding contact with the cutout portion 113b of the plunger plate 110 when the plunger 112 is pressed.

In the resin tablet disposing portion 132, the support wall 132b is erected so as to surround the resin tablet 150. The resin tablet 150 is held in the resin tablet disposing portion 132 by the support wall 132b.

In addition, the respective resin tablet disposing portions 132 are disposed at equal intervals on the circumference with the axial center X of the rotor core 20 as a center, and are disposed substantially at an intermediate position between the axial center X of the rotor core 20 and the magnet insertion hole 14. That is, the resin tablets 150 disposed on the resin tablet disposing portions 132 are also disposed at equal intervals on the circumference with the axial center X of the rotor core 20 as a center, and are disposed substantially at the intermediate position between the axial center X of the rotor core 20 and the magnet insertion hole 14, for example, the position closer to the magnet insertion hole 14 rather than the axial center X of the rotor core 20.

Further, the gate plate 130 is provided with gates 134, which are a plurality of resin flow channels and radially extend from the resin tablet disposing portions 132 toward the magnet insertion hole 14 in a radial direction. A branching portion 136 is formed at a tip part of the gate 134 so as to extend to the resin grooves 14a of the three magnet insertion holes 14 constituting the magnetic pole 41. Here, as illustrated in FIGS. 5A and 5B, the internal space of the resin tablet disposing portion 132 communicates with the gate 134.

Further, a connection groove 138 is formed in the gate plate 130 such that the gates 134 are annularly connected to each other.

As illustrated in FIGS. 2A and 2B, the resin injection plate 140 is formed in a rectangular flat plate shape, and a plurality of resin injection holes 142 are formed at positions corresponding to the resin grooves 14a of the rotor core 20 so as to extend in the axial direction toward the magnet insertion hole 14. The resin injection hole 142 of the resin injection plate 140 guides the resin supplied from the gate 134 of the gate plate 130 to the resin groove 14a of the rotor core 20.

Two die pins 144 are fixed upward to the resin injection plate 140 on diagonal lines, so that the plunger plate 110, the cylinder plate 120, the gate plate 130, and the resin injection plate 140 to be stacked are positioned with respect to each other and each die plate is guided up and down during press molding of the transfer molding die 100.

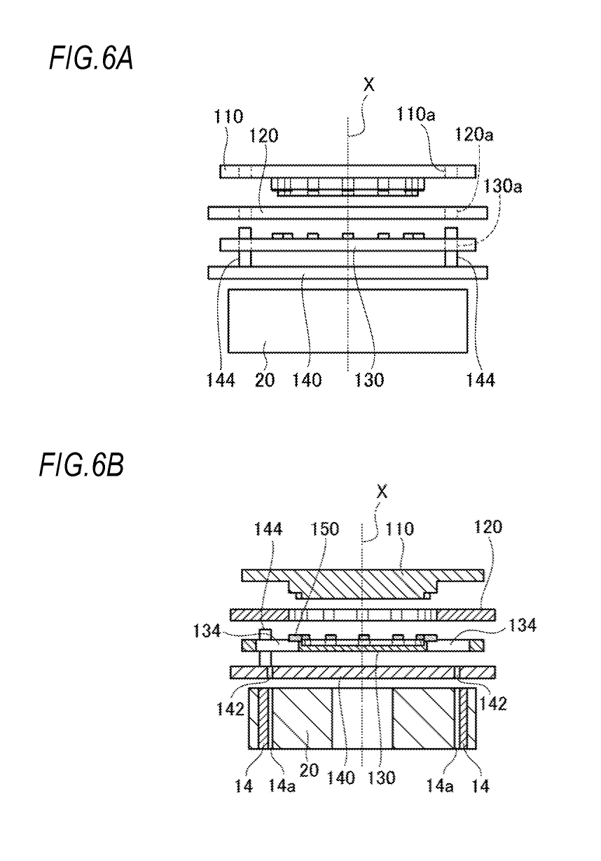

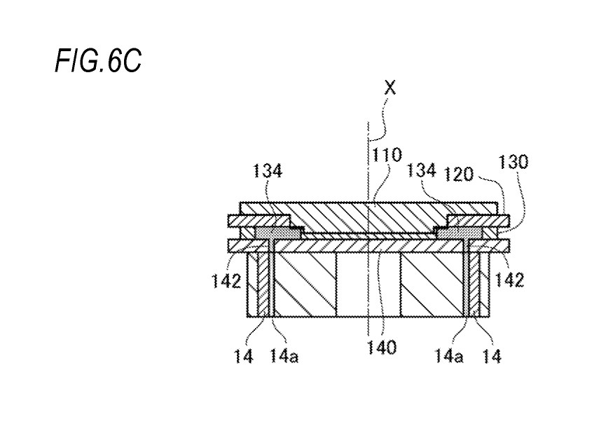

For this reason, as illustrated in FIG. 6A, the plunger plate 110, the cylinder plate 120, and the gate plate 130 are formed with two guide holes 110a, two guide holes 120a, and two guide holes 130a, respectively, through which the die pin 144 can be inserted 110a.

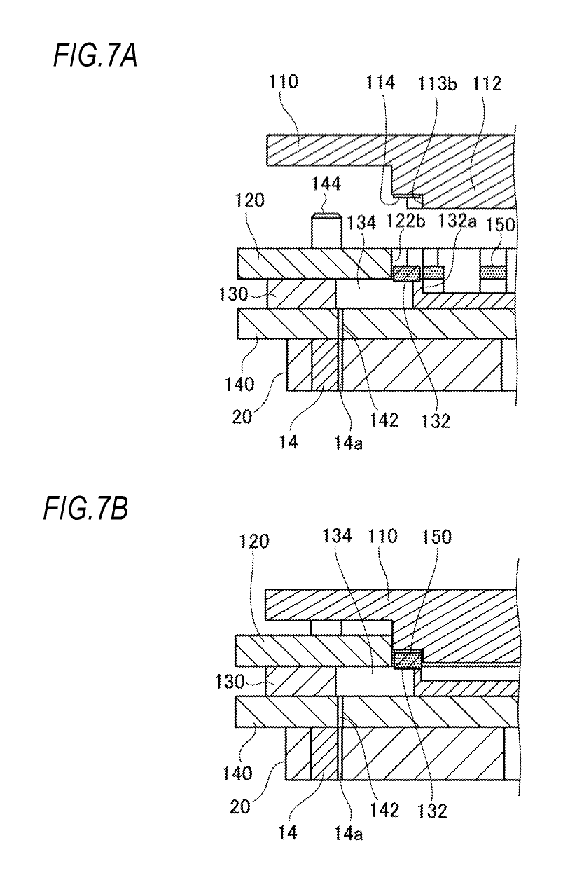

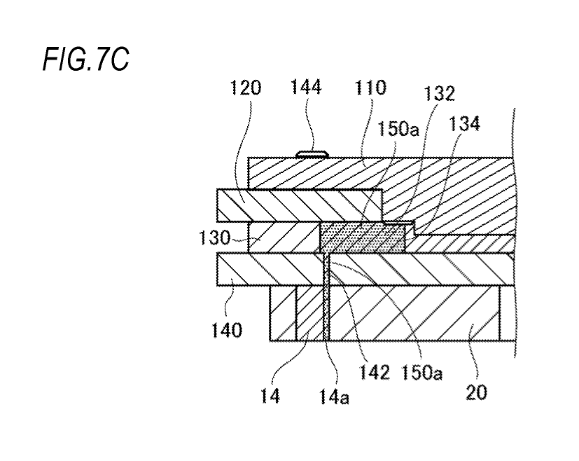

As illustrated in FIGS. 2A and 2B, since the transfer molding die 100 is placed above the rotor core 20 during the transfer molding, the upper end face 22 of the rotor core 20 is sealed by the resin injection plate 140. Then, as illustrated in FIGS. 6C and 7C, the resin groove 14a of the rotor core 20 communicates with the resin injection hole 142 of the resin injection plate 140.

In addition, the resin injection hole 142 communicates with the branching portion 136 when abutting on the gate plate 130. Therefore, the magnet insertion hole 14 communicates with the resin tablet disposing portion 132 via the resin groove 14a, the resin injection hole 142 of the resin injection plate 140, and the branching portion 136 and the gate 134 of the gate plate 130. Thus, a resin path is formed through which resin 150a of the resin tablet disposing portion 132 reaches the magnet insertion hole 14 of the rotor core 20.

Although not illustrated, a lower die is disposed below the rotor core 20 so as to close the lower end of the magnet insertion hole 14 formed in the rotor core 20 by abutting against the lower surface of the rotor core 20.

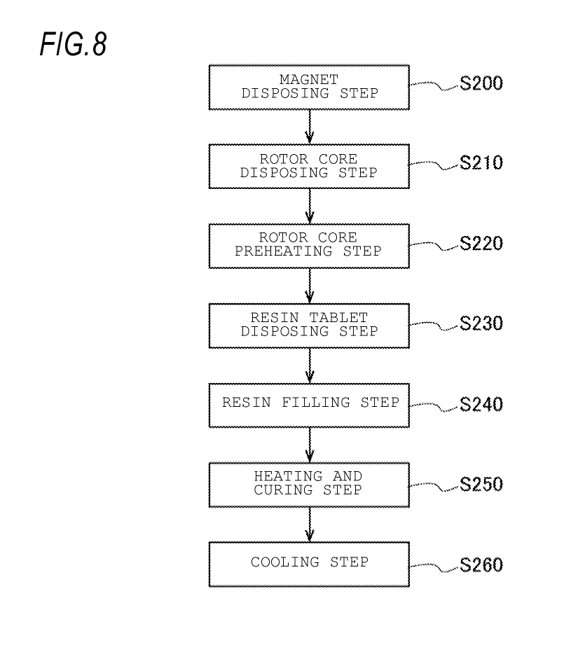

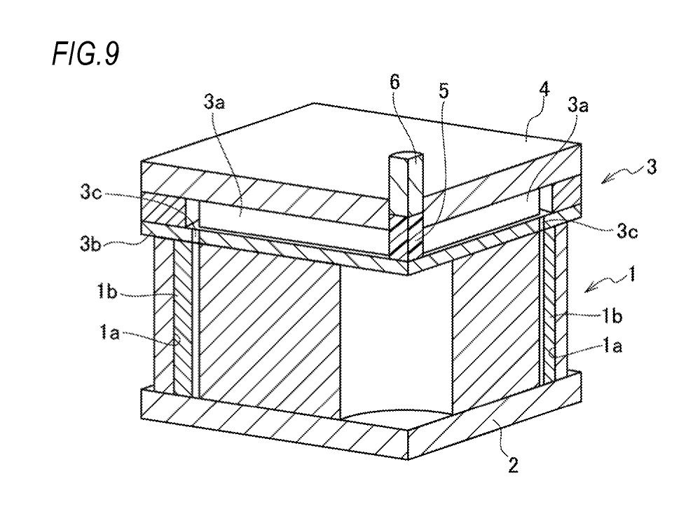

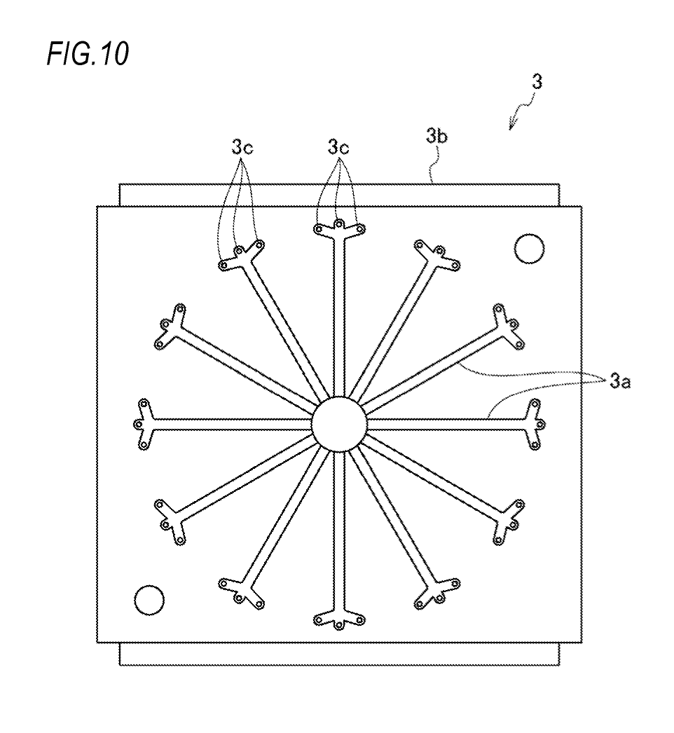

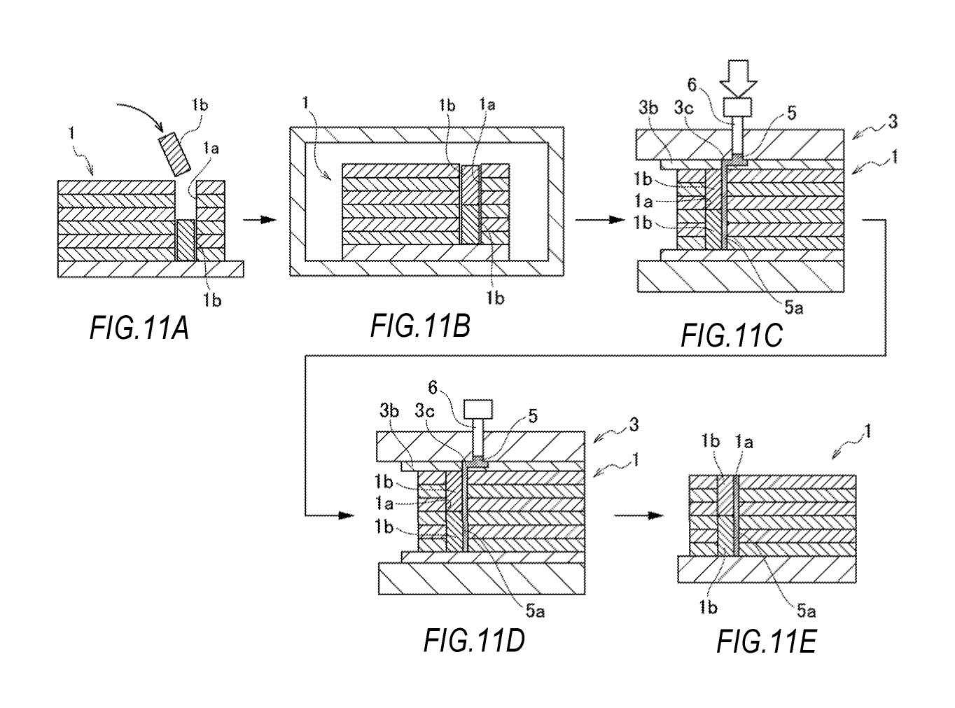

The rotor manufacturing method according to the embodiment will be described below with reference to a flowchart of FIG. 8.

In magnet disposing step S200, the permanent magnet 40 is disposed by being inserted into each of the magnet insertion holes 14 of the rotor core 20.

In rotor core disposing step S210, as illustrated in FIGS. 2A and 2B, the transfer molding die 100 is disposed above the rotor core 20 in which the permanent magnet 40 is disposed in the magnet insertion hole 14. More specifically, the resin injection plate 140, the gate plate 130, the cylinder plate 120, and the plunger plate 110 are stacked in this order from the bottom.

In this case, as illustrated in FIG. 6A, each of the die pins 144 of the resin injection plate 140 is inserted into the guide hole 110a of the plunger plate 110, the guide hole 120a of the cylinder plate 120, and the guide hole 130a of the gate plate 130, whereby the plunger plate 110, the cylinder plate 120, the gate plate 130, and the resin injection plate 140 are positioned with respect to each other.

Subsequently, in rotor core preheating step S220, the rotor core 20 having the magnet insertion holes 14, into which the permanent magnet 40 is inserted, is preheated together with the transfer molding die 100.

In resin tablet disposing step S230, as illustrated in FIG. 5B, the resin tablet 150 for one shot is disposed in each of the resin tablet disposing portions 132.

In resin filling step S240, as illustrated in FIGS. 7A to 7C, the plunger 112 of the plunger plate 110 is pressed downward. Thus, the resin tablet 150 disposed in the resin tablet disposing portion 132 is pressurized by each of the pressing portions 114 of the plunger 112 in the cylinder 122.

The resin tablet 150 is pressurized in a state where the outer periphery thereof is constrained by the cutout portion 113b of the plunger base 113 and the semicircular groove 122b of the cylinder plate 120, so that the resin 150a flows into the gate 134 from each of the resin tablet disposing portions 132 of the gate plate 130, and flows into the resin groove 14a of the rotor core 20 by passing through the resin injection hole 142 of the resin injection plate 140 from the branching portion 136, thereby being filled between the magnet insertion hole 14 and the permanent magnet 40.

In heating and curing step S250, the rotor core 20 filled with the resin 150a in the resin filling step S240 is heated together with the transfer molding die 100 by a heating furnace, for example. Therefore, the resin material filled between the magnet insertion hole 14 and the permanent magnet 40 is cured.

Finally, in cooling step S260, the rotor core 20 is cooled down together with the transfer molding die 100 by a cooling furnace, for example. Therefore, the permanent magnet 40 is firmly fixed to the magnet insertion hole 14 of the rotor core 20. In the cooling step S260, only the rotor core 20 may be cooled excluding the transfer molding die 100, and the cooling by natural heat radiation may be performed instead of the cooling by the cooling furnace.

As described above, according to the embodiment, the plurality of resin tablets 150 are disposed to be annularly spaced from each other in the resin tablet disposing step S230, and the resin 150a is filled between the magnet insertion hole 14 and the permanent magnet 40 in the resin filling step S240 when the plurality of resin tablets 150 are pressed by one plunger 112.

In this way, the resin 150a is injected into the plurality of magnet insertion holes 14 using the plurality of resin tablets 150 disposed to be annularly spaced from each other, and thus the distance from the resin tablet 150 to the magnet insertion hole 14 can be shortened and the amount of cull being a residual cured product can be reduced, compared with a case where the resin 150a is injected into the plurality of magnet insertion holes 14 using one resin tablet 150 disposed at the center of the rotor core 20. Since the cull remains in the entire resin path, the amount of cull remaining in the resin path is approximately proportional to the length of the entire resin path.

In addition, since the plurality of resin tablets 150 are pressed by one plunger 112, the plunger 112 can be easily controlled compared with a case where the resin tablets 150 are pressed by a plurality of plungers, respectively. Further, since so-called transfer molding is adopted in which the resin tablet 150 is pressed by the plunger 112, the injection pressure can be set to be lower compared with injection molding.

In addition, since the plurality of resin tablets 150 are disposed at equal intervals on the circumference with the axial center X of the rotor core 20 as a center and the plunger 112 has the plurality of pressing portions 114, the load can be evenly applied to the plurality of resin tablets 150 at the time of pressing with one plunger 112.

Furthermore, since the resin tablet 150 is disposed in the resin tablet disposing portion 132 surrounded by the support wall 132b, the resin tablet 150 can be firmly held.

In addition, since the resin tablet 150 is disposed substantially at the intermediate position between the axial center X of the rotor core 20 and the magnet insertion hole 14, it is possible to reduce the amount of cull which is a residual cured product, compared with a case where the resin tablet is disposed on the axial center X of the rotor core 20.

The transfer molding die 100 includes the plunger plate 110 on which the plunger 112 is formed, the cylinder plate 120 on which the cylinder 122 through which the plunger 112 is inserted, the gate plate 130 on which the plurality of resin tablet disposing portions 132 disposed with the resin tablets 150 are formed and on which the gate 134 extending in the radial direction from the resin tablet disposing portion toward the magnet insertion hole 14 is formed, and the resin injection plate 140 in which the resin injection hole 142 communicating with the gate 134 and extending in the axial direction toward the magnet insertion hole 14 is formed.

Therefore, each plate (die) can be formed according to the function. In addition, the gate plate 130 formed with the gate 134 as the radial resin flow channel is separated from the resin injection plate 140 formed with the resin injection hole 142 as the axial resin flow channel, and thus it is possible to easily remove the cull which is the residual cured product.

Further, since the annular connection groove 138 is formed in the gate plate 130 to connect the gates 134 with each other, the gates 134 communicate with each other and the pressure can be uniformly applied during the injection of the resin 150a.

It should be noted that the present invention is not limited to the above-described embodiment, but can be modified and improved as appropriate.

### DESCRIPTION OF REFERENCE NUMERALS AND CHARACTERS

14 magnet insertion hole
20 rotor core
22 end face (upper end face)
40 magnet (permanent magnet)
43 resin portion
100 resin filling die (transfer molding die)
112 plunger
114 pressing portion
110 first plate (plunger plate)
120 second plate (cylinder plate)
122 cylinder
130 third plate (gate plate)
132 resin tablet disposing portion
132b support wall
134 radial resin flow channel (gate)
138 connection groove
140 fourth plate (resin injection plate)
142 axial resin flow channel (resin injection hole)
150 resin tablet
150a resin
S230 resin tablet disposing step
S240 resin filling step

1. A rotor manufacturing method of manufacturing a rotor including
a rotor core having a plurality of magnet insertion holes,
a magnet which is disposed in the magnet insertion hole, and
a resin portion which is filled between the magnet and the magnet insertion hole,
wherein the method comprises the steps of:
disposing a plurality of resin tablets to be annularly spaced from each other; and
filling resin between the magnet insertion hole and the magnet by pressing the plurality of resin tablets with one plunger.

2. The rotor manufacturing method according to claim 1,
wherein the plurality of resin tablets are disposed at equal intervals on a circumference with an axial center of the rotor core as a center, and
the plunger has a plurality of pressing portions.

3. The rotor manufacturing method according to claim 1,
wherein the resin tablet is disposed in a resin tablet disposing portion surrounded by a support wall.

4. The rotor manufacturing method according to claim 1,
wherein the resin tablet is disposed substantially at an intermediate position between the axial center of the rotor core and the magnet insertion hole.

5. The rotor manufacturing method according to claim 1,
wherein a resin filling die is provided on one end face in an axial direction of the rotor core, and
the resin filling die includes
a first plate where the plunger is formed,
a second plate where a cylinder is formed, the plunger being inserted through the cylinder,
a third plate where a plurality of resin tablet disposing portions and a plurality of radial resin flow channels are formed, wherein the resin tablets are disposed in the resin tablet disposing portions, and the radial resin flow channels extend in a radial direction from the resin tablet disposing portions toward the magnet insertion holes, and
a fourth plate where a plurality of axial resin flow channels are formed, wherein the axial resin flow channels communicate with the radial resin flow channels and extend in an axial direction toward the magnet insertion holes.

6. The rotor manufacturing method according to claim 5,
wherein an annular connection groove is formed in the third plate to connect the radial resin flow channels with each other.
